(19) United States
(12) Patent Application Publication
(10) Pub. No.: US 2018/0306191 A1
(43) Pub. Date: Oct. 25, 2018

(54) SUPERCHARGER INLET PANELS

(71) Applicant: Eaton Corporation, Cleveland, OH (US)

(72) Inventor: Geon-Seok Kim, Novi, MI (US)

(73) Assignee: Eaton Corporation, Cleveland, OH (US)

(21) Appl. No.: 15/524,796

(22) PCT Filed: Nov. 5, 2015
(86) PCT No.: PCT/US2015/059215

§ 371 Date: May 5, 2017

Related U.S. Application Data
(60) Provisional application No. 62/075,852, filed on Nov. 5, 2014.
(60) Provisional application No. 62/150,374, filed on Apr. 21, 2015.
(60) Provisional application No. 62/163,608, filed on May 19, 2015.
(60) Provisional application No. 62/174,334, filed on Jun. 11, 2015.

(51) Int. Cl. F04C 29/12; F04C 29/06; F02B 33/38

(52) U.S. Cl. CPC F04C 29/12; F04C 18/126; F02B 33/38; F04C 29/063

(57) ABSTRACT

An inlet panel for a supercharger comprises a first portion, the first portion comprising one of a perforated material, a micro-perforated material, and a mesh layer. The inlet panel also comprises a second portion, the second portion comprising a recess and an axis. The recess is bordered in part by a side wall and a back wall. The first portion is offset from the back wall in the axial direction. The side wall has an edge located a distance away from the back wall in the axial direction.

### FIELD

This application relates to superchargers comprising an inlet panel with air pulsation damping.

### BACKGROUND

Air pulsation is a dominant noise source in engine intake system air moving devices such as superchargers. Reactive acoustic elements, such as Helmholtz resonators, have been used in vehicle intake systems to damp low frequency narrow band noise. But the reactive acoustic elements have limited application in vehicle intake systems because they can be large in size, requiring substantial volume. Dissipative elements, like foam or fiberglass can be used, however, they are effective only with high frequency noise. Foam and fiberglass have also been avoided because they can contaminate the air flow, potentially damaging the supercharger or engine in addition to reducing performance.

### SUMMARY

The devices disclosed herein overcome the above disadvantages and improve the art by way of providing noise damping to a supercharger using a perforated material as part of an inlet panel.

An inlet panel for a supercharger comprises a first portion, the first portion comprising one of a perforated material, a micro-perforated material, and a mesh layer. The inlet panel also comprises a second portion, the second portion comprising a recess and an axis. The recess is bordered in part by a side wall and a back wall. The first portion is offset from the back wall in the axial direction. The side wall has an edge located a distance away from the back wall in the axial direction.

A supercharger comprises a housing comprising a bore, at least two rotors, the rotors each positioned in the bore, a radial outlet, an axial inlet, and an inlet panel adjacent the inlet. The inlet panel comprises a first portion, the first portion comprising one of a perforated material, a micro-perforated material, and a mesh layer. A second portion comprises a recess and an axis, wherein the recess is bordered in part by a side wall and a back wall. The first portion is offset from the back wall in the axial direction. The side wall has an edge located a distance away from the back wall in the axial direction.

A supercharger assembly comprises a housing. The housing comprises an inlet plane and an inlet in the inlet plane, an outlet plane, and an outlet in the outlet plane, at least two rotor bores connected to the inlet, at least two rotors positioned in the at least two rotor bores, and an opening above the inlet. An inlet panel assembly comprises a first portion comprising one of a perforated material, a micro-perforated material, and a mesh layer adjoining the opening. An inlet panel adjoins the perforated material to secure the perforated material against the housing.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

### BRIEF DESCRIPTION OF THE DRAWINGS

FIG. 1 is a view of an inlet panel without a perforated panel.

FIG. 2 is a view of an inlet panel with a perforated panel.

FIG. 3 is a view of an inlet panel with a perforated panel and a porous material.

FIG. 4 is a view of an inlet panel with a mesh panel and a porous material.

FIG. 5 is a perspective view of a supercharger housing with an inlet panel, looking at the outside of the housing.

FIG. 6 is a perspective view of a supercharger housing with an inlet panel, looking toward the inlet panel through the bore of the housing.

FIG. 6 is a perspective view of a supercharger housing without an inlet panel.

FIG. 8 is a view of a supercharger housing without an inlet panel, looking into the housing from the radial outlet side.

FIG. 9 is a view of a supercharger housing without an inlet panel, looking into the housing toward the axial-side inlet.

FIG. 10 is a view of a supercharger housing looking into the axial-side inlet.

FIGS. 11A-11C show an alternative inlet panel assembly and supercharger housing.

FIG. 12 is a cross-section of an alternative inlet panel assembly.

FIG. 13 is a cross-section of an alternative inlet panel assembly.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

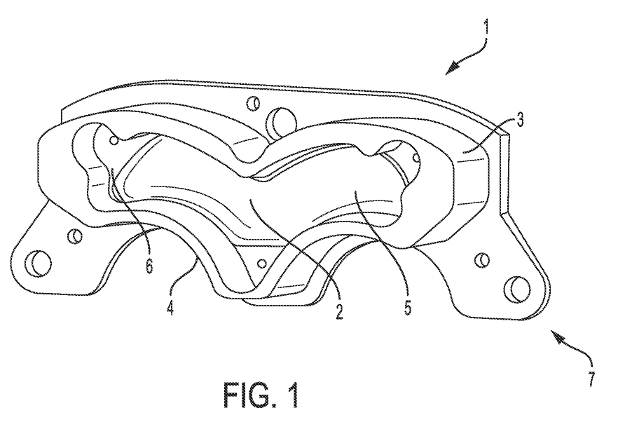

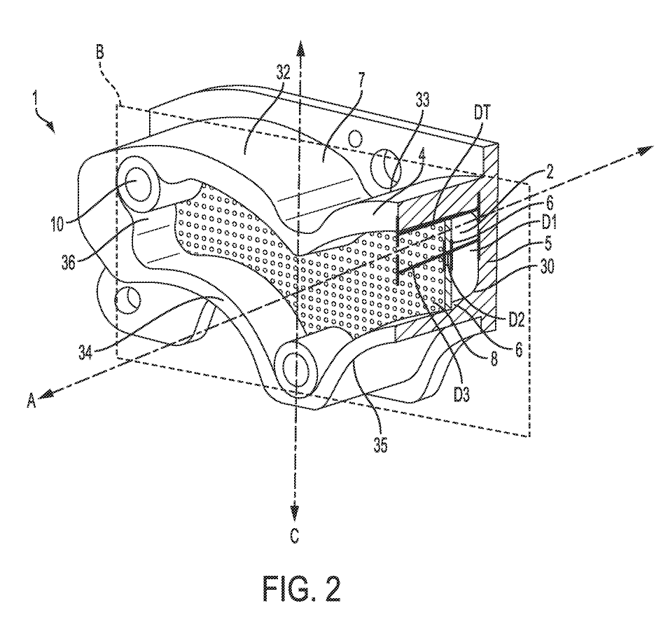

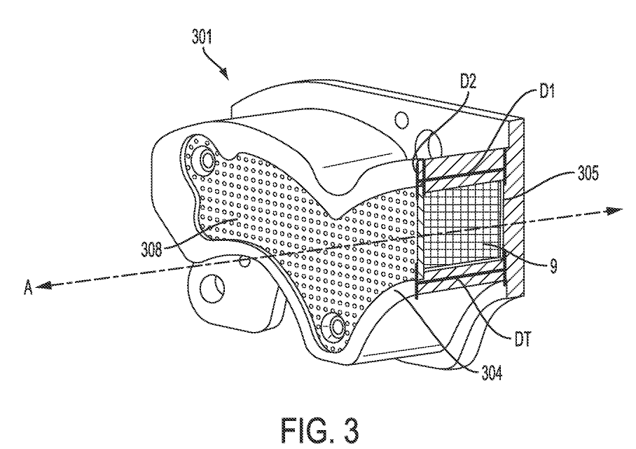

FIG. 1 is a view of an inlet panel without a perforated panel. The inlet panel 1 has a recess 2 surrounded by a side wall 3. The side wall 3 has an edge 4. Between the edge 4 and the back wall 5 is a step 6. The depth and dimensions of the recess 2 can be selected to dampen particular frequencies. The example in FIG. 1 shows a second portion 7 of an inlet panel 1. In FIG. 1, the second portion 7 is an inlet panel 1 that does not have either a perforated material or a porous material. As shown in FIGS. 2 and 3, a perforated material (e.g. first portion 8), a porous material (e.g. porous material 9), or both a perforated material and a porous material can be attached to the second portion 7 to form an inlet panel with additional capabilities to dampen noise.

FIG. 2 is a view of an inlet panel with a first portion 8. The first portion 8 is a layer comprising a porosity. The layer of the first portion can be a perforated panel, micro-perforated panel, mesh layer, or other material that dampens noise. The material of the first portion 8 and the dimensions of the perforations can be selected to dampen particular frequencies. The porosity can be selected to impact air flow through the inlet panel. Also, the location of the first portion 8 can be selected to dampen noise. For example, the first portion 8 can rest on a step 6 or on a side wall 3 of the second portion 7. The inlet panel 1 of FIG. 2 has an axis A. The location of the first portion 8 can be selected based on its distance from the back wall 5 in the axial direction along axis A. The ability to dampen particular frequencies changes as the first portion 8 moves farther away or closer to the back wall 5. The step 6 can be placed at a selected depth so that the first portion 8 abuts step 6. The back wall 5 can be parallel to the first portion 8 and positioned in a plane B perpendicular to axis A.

The first portion 8 can have perforations of a circular shape or other shapes of various diameters and dimensions, such as slits, crenellations, squares, or rectangles. The dimensions and perforation sizes of the micro-perforated panel can be selected and transfer impedance predicted using the equations (1)-(3) below.

Equation 1 can be used to calculate the transfer impedance, where Zₜᵣ is the transfer impedance.

$${Z}_{tr} = \frac{Δ p}{ρ c v} = \frac{32 η t}{σρ c {d}^{2}} ( {( 1 + \frac{{β}^{2}}{32} )}^{1 / 2} + \frac{\sqrt{2}}{8} β \frac{d}{t} ) + j \frac{ω t}{σ c} ( 1 + {( {3}^{2} + \frac{{β}^{2}}{32} )}^{- 1 / 2} + 0.85 \frac{d}{t} ) \qquad eq . ( 1 )$$

In equation (1), the variables and constants are defined as follows:

d=pore diameter

t=panel thickness (e.g. thickness of first portion 8 along axis A)

D=depth of the backing cavity

η=dynamic viscosity

σ=porosity

c=speed of sound

ρ=density of air

ω=angular frequency

Δp=pressure difference

Equation 2 can be used to calculate beta (n), as follows:

β=d\sqrt{ωρ/4η} eq. (2)

Equation 3 can be used to calculate the transfer impedance (Z) with the backing space. Equation 3 is defined as follows:

$$Z = {Z}_{tr} - j cot \frac{ω D}{c} \qquad eq . ( 3 )$$

Z=the transfer impedance with the backing space

j is an imaginary unit, where j²=−1

cot=cotangent.

Equation 4 can be used to calculate αₙ—the normal sound absorption coefficient, where rₙ and xₙ are the real and imaginary parts of the total impedance.

$${α}_{n} = \frac{4 {r}_{n}}{{( 1 + {r}_{n} )}^{2} + {x}_{n}^{2}} \qquad eq . ( 4 )$$

D, the depth of the backing cavity in the above equation, is illustrated in FIG. 2 as D1. The panel thickness t in the above equation, is illustrated in FIG. 2 as D2. D1 is the distance along axis A from back wall 5 to the first portion 8 surface nearest the back wall 5. D2 is the distance along axis A of the thickness of first portion 8. D3 is the distance along axis A from edge 4 to the first portion 8 surface nearest the edge. DT is the sum of distances D1, D2, and D3. The edge 4 is located at the end of the side wall 3 away from back wall 5 in the direction along axis A. Thus, the edge 4 of inlet panel 1 is a total distance DT away from the surface of back wall 5 measured along axis A

FIG. 3 is a view of an inlet panel 301 with a perforated panel (first portion 308) and a porous material 9. The dimensions, location, and material of the porous material 9 can be selected to dampen particular frequencies. As with the location of the first portion 8 in FIG. 2, the location of the porous material 9 affects the ability of the inlet panel 301 to dampen particular frequencies. The porous material 9 can abut both the first portion 308 and the back wall 305 or it can abut neither the first portion 308 nor the back wall 305. It can be placed in between the first portion 308 and the back wall 305 so that it does not abut either the back wall 305 or the first portion 308. It can also abut either first portion 308 only or back wall 305 only. That is, the porous material 9 and perforated panel 308 can be spaced to provide air gaps in in the recess 2.

In FIG. 3, D1 is the distance along axis A from back wall 305 to the first portion 308 surface nearest back wall 305. D2 is the distance along axis A of the first portion 308, or thickness of first portion 308. DT is the sum of distances D1 and D2. The recess 2 extends from edge 304 along axis A to the surface of back wall 305 for a total distance DT. Spacers 510 are not needed because the first portion 308 includes pilot holes for mounting means, such as rivets or screws.

As shown in FIG. 2, the portion between back wall 5 and first portion 8 can be hollow for a distance of D1 along axis A. Low pressure air is transferred to a high pressure region though the first portion 8. A majority of air passes through the hollow recess in the region of D3 and creates a very high level of turbulence. The turbulence level of air entering through the perforated panel, first portion 8, is reduced in the hollow portion in the region of D1. Or, as shown in FIG. 3, the porous material 9 fills the space so that the thickness of the porous material is D1 along axis A. Air with the reduced turbulence intensity is reflected back to the first portion 8 and dampens the total turbulence intensity.

In FIG. 2, the back wall 5 is in a plane B perpendicular to axis A. The interface 30 between the back wall 5 and the edge 4 can be rounded, as shown, or the interface can be squared off. The perforated panel (first portion 8) extends for a distance D2 along axis A. To facilitate turbulence or tune air flow, the recess 2 of the inlet panel 1 can include a third distance D3 between the edge 4 and the first portion 8. The recess 2 can be empty for the third distance D3 and the curvature of the recess 2 edges 32-36, and corresponding mirror edges along axis C, tune the air flow prior to first portion 8. The total distance DT of the recess 2 can be chosen based on the application and the resulting first, second, and third distances are also selected to tune the air flow. Thus, D3 can be greater than, less than or equal to D2 or D1. D2 can be greater than, less than, or equal to D3 or D1. And D1 can be greater than, less than, or equal to D3 or D2. As shown in FIG. 3, the third distance D3 can be omitted. Edge 4 comprises curved edges that tune the air flow in recess 2. The curved edges are mirror images about center axis C. Spacers 10, shown in FIG. 2, can be used to space the first portion 8 with respect to the edge 4, or with respect to the back wall 5. Spacer can also be used to space the porous material 9. When spacers include threading, screws can be used to secure the first portion 8 in the recess 2. One or more steps 6 can be used to orient the porous material 9 and the first portion 8 can abut a step 6. A spacer 10 can then be used to secure the first portion 8 against the step 6.

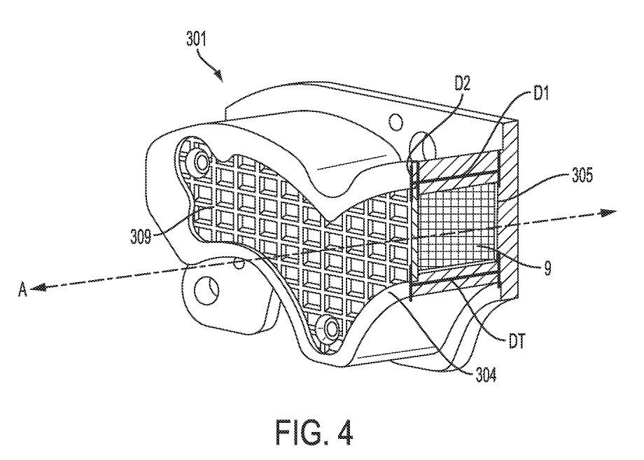

FIG. 4 shows an alternative to FIG. 3, where first portion is a mesh panel 309 instead of a perforated panel. The mesh panel 309 retains the porous material 9 in the inlet panel 301.

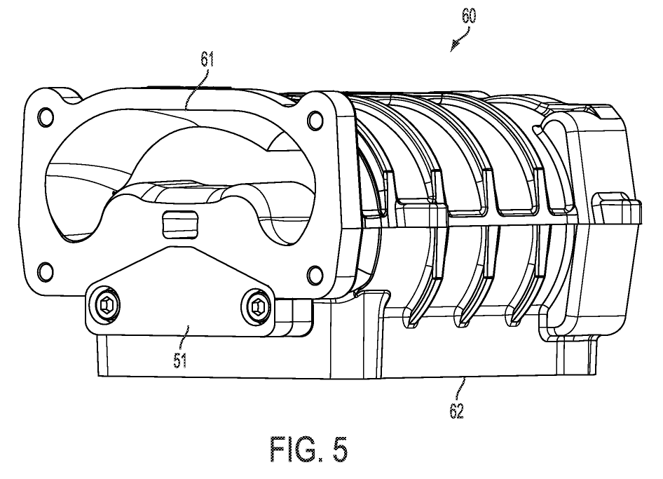

FIG. 5 shows an arrangement where an inlet panel 51 is attached to a housing 60 of a supercharger on the inlet 61 side of the housing 60. Air flows through the inlet 61 of the housing and out the outlet 62 of the housing. The cavity in the inlet panel 51 induces back flow, which promotes smoother transition from low to high pressure in the supercharger. Superchargers with back flow generate less noise than those without back flow. Even with back flow, however, superchargers can generate high air pulsation noise. Back flow is a cause of this pulsation. The inlet panel 51 can suppress the noise by providing resistance to the acoustic wave movement.

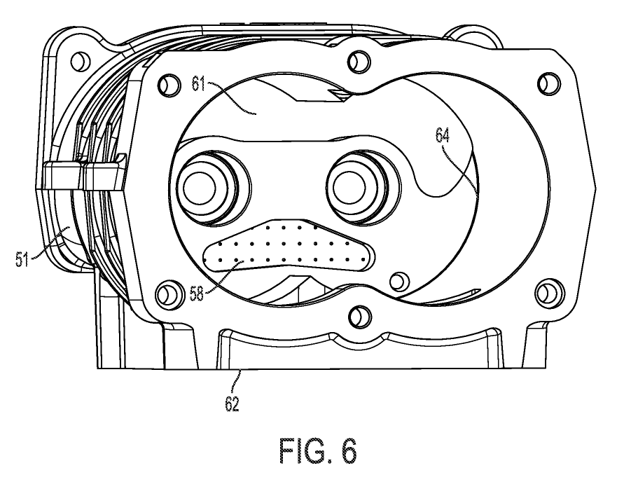

FIG. 6 shows the same arrangement as FIG. 5, but from a perspective looking through the bores 64 toward the inlet 61 side of the housing. There are no rotors shown in this view. First portion 58, a perforated panel, can be seen on the inlet 61 side of the housing 60. During back flow compression, air leaks back from the outlet 62 toward first portion 58 as the rotors turn. First portion 58 can dampen noise caused by the back flow compression.

The example shown in FIGS. 5 and 6 could use any of the inlet panels shown in FIGS. 1-4. Also, the example in FIGS. 4 and 5 could use any of the arrangements described herein to dampen specific frequencies. Recess depths, contours of the inlet panel, porous material selection, porous material dimensions, perforated material selection, perforated material dimensions, back flow ports and other aspects can be modified to, among other things, dampen certain frequencies and fit the supercharger housing. The exemplary contours, such as the arcing panel of FIGS. 1-4, the quasi-triangular irregular hexagon of FIGS. 5 & 6, and the mushroom shape of FIGS. 7 & 10 are exemplary contours and other shapes are contemplated.

Any of the arrangements described above could also be assembled so that a mounting insert (e.g. gasket, bushing plate, spacer) is placed between the inlet panel and the housing. Also, while the arrangements above show an inlet panel that can be separate from the supercharger housing and then fastened to the supercharger housing to form a single unit, the inlet panel could be an integral part of the housing, thus, requiring no fasteners. In this arrangement, the inlet panel could be formed in the same manner and at the same time as the supercharger housing, for example, machined, cast, printed using a three-dimensional printer, or a combination of all the above. One or both of the porous material and the perforated material, when used, can be installed on the integrated second portion.

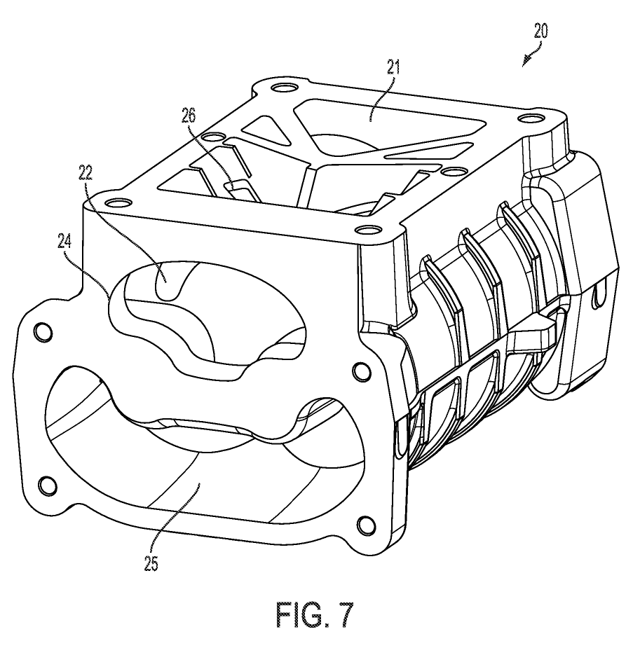

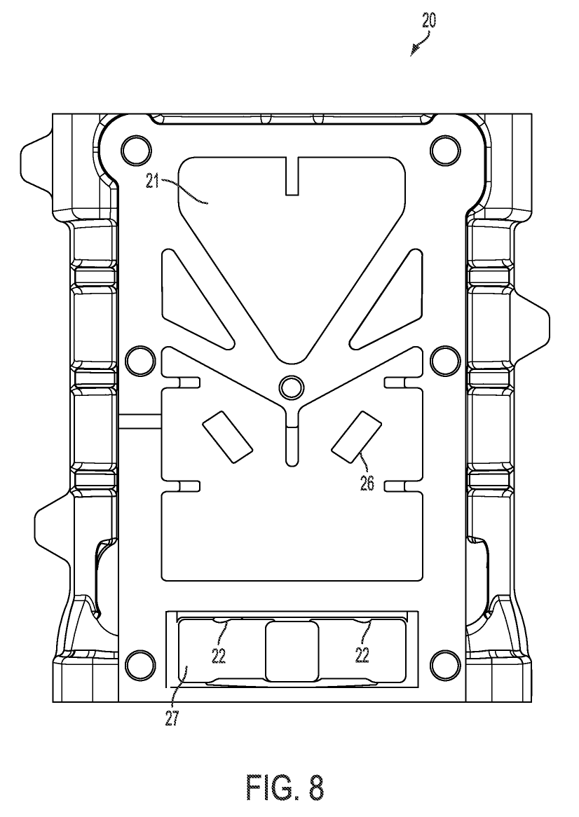

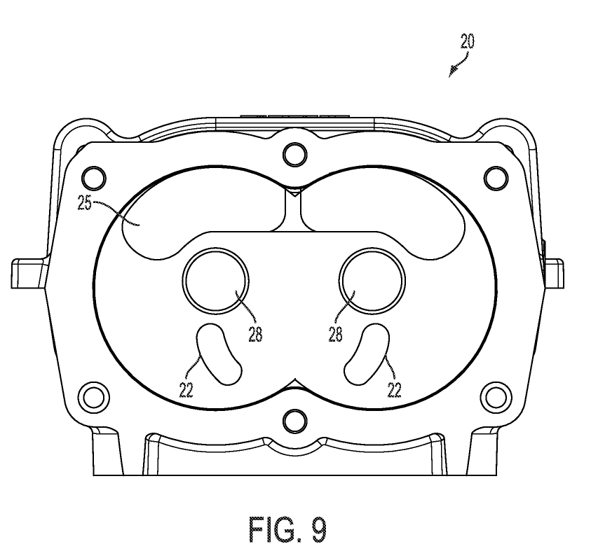

FIG. 7 is a supercharger housing 20 without an inlet panel installed. It has a radial side outlet 21, inlet-side back flow ports 22, an opening 24 for mounting an inlet panel, an axial-side inlet 25, and an outlet-side back flow port 26. FIG. 8 is another view of the supercharger housing 20, looking into the housing from a radial side. The housing 20 has a radial side outlet 21, outlet-side back flow port 26, and a back flow air compartment 27, where the housing 20 can receive turbulent air flow through the inlet-side back flow ports 22 during a back flow compression process. FIG. 9 is another view of the supercharger housing 20, looking axially into the rotor bores of the housing 20 toward the inlet side, which includes inlet-side back flow ports 22, rotor mounting holes 28, and an axial-side inlet 25.

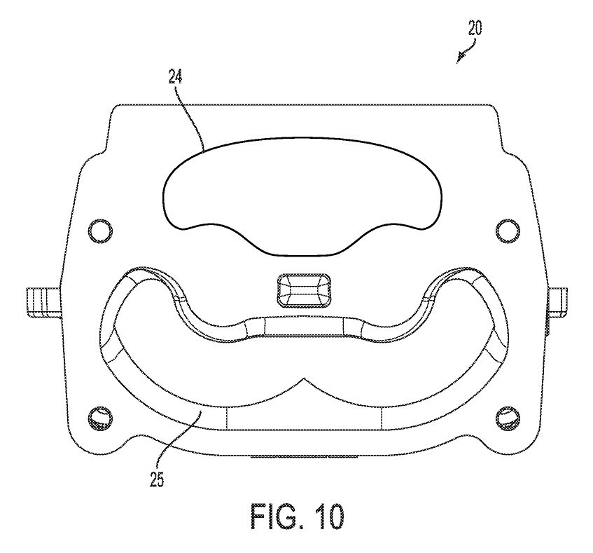

FIGS. 7-9 can damp noise and turbulence through one or more of the axial flow back flow ports 22, the radial flow back flow ports 26, or the outlet 21. The housing can comprise only axial flow back flow ports 22, only radial flow back flow ports 26, or, as drawn, both radial flow back flow ports 26 and axial flow back flow ports 22. FIGS. 5, 6 & 10 do not include a back flow air compartment or inlet-side back flow ports. Instead, the housings drawn in FIGS. 5, 6 & 10 damp turbulence and noise caused by back flow of air through the outlet and in to the inlet side inlet panel 301. As a further alternative, the housing of FIGS. 5, 6 & 10 can further comprise radial flow back flow ports 26. FIG. 10 is a view of the supercharger housing looking into the opening 24 and the axial-side inlet 25.

In Roots style pumps, back flow compression processes at an outlet port cause high level air pulsation. To mitigate this, inlet-side backflow slots have been devised to create a channel to introduce high pressure outlet air in to the low pressure transfer volume trapped inside the supercharger. While this reduces outlet air pulsation noise in a wide supercharger speed operating range, high level air pulsation remains. The inlet-side backflow slots cause aerodynamic losses due to air flow leakage.

By adding an inlet panel parallel to the inlet side of the supercharger and in fluid communication with the inlet-side backflow slots, air pulsation in the inlet-side backflow ports can be reduced. By adding turbulence dissipation elements, further reductions in air pulsation are achieved. The inlet panel is advantageous over other reactive or dissipative acoustic elements in the vehicle air intake system because this arrangement treats the noise problem at its source.

When the air in a transfer volume encounters the inlet-side backflow slot, air flow jets arise to equalize the pressure difference between the air at the inlet-side backflow slot and the air in the transfer volume. The turbulence of the air flow jets can be reduced by attaching an inlet panel parallel to the axial inlet side of the housing. The panel can be spaced from the backflow slots to accomplish noise damping while limiting unwanted air leakage and limiting the extent that air flow in to the transfer volume is impeded.

Small eddies of turbulence can be further reduced by introducing porous material at a location near the inlet-side backflow slots. The eddies dissipate as they pass through the tortuous path of the porous material.

The inlet side backflow ports 22 and the outlet side (radial flow) backflow ports 26 can be used together, as shown in FIGS. 7-9. Or, only one of the inlet or outlet side backflow ports can be used. It is possible to omit the backflow air compartment 27, integrating the inlet panel with the inlet wall of the supercharger housing, to suppress one or both of backflow through the outlet, or, if included, backflow through outlet side backflow ports 26.

Porous materials such as melamine foams, fiberglass, or mineral glue are subject to deterioration at the operating pressures and heat ranges of a supercharger. But, the first portion 8, 308, in the form of a micro-perforated panel, perforated panel, or mesh, can be used instead of, or with, the porous material. A micro-perforated panel is a sheet material with a one-millimeter or sub-millimeter hole diameter. One example of a micro-perforated panel is MILLENNIUM METAL by American Acoustical Products, a division of Ward Process, Inc. Perforations in the micro-perforated panel can be circular, slits, or holes of other shapes.

When the first portion, such as the micro-perforated panel, is used with the porous material, the hole size of the micro-perforated panel can be tailored to trap broken down particles of the porous material to avoid contamination. Material selection is also expanded to be chosen from BASOTECT open cell foam by BASF: The Chemical Company, or comparable materials, other melamine foams, melamine resins, or thermoset polymers, or NOMEX flame resistant fiber by DuPont, or comparable materials, or fiberglass, or mineral glue.

The porous material and first portion smooth the backflow compression process. The porous material and first portion, alone or in combination, provide the benefit of reducing reverberation time of the cavity, which also reduces noise.

When using the porous material and first portion together, it can be beneficial to use the porous material to damp high frequency noise, while tuning the perforated panel to damp the most problematic frequency range, or another range not covered by the porous material. Because the micro-perforated panel can have damping properties in between current reactive and dissipative elements, it is a good addition to a system to augment noise solutions.

Tuning the damped frequencies can be achieved by placing the first portion a selected distance away from the back wall of the second portion. A backing space is thus created in the recess. To combine the damping properties of the second portion with the first portion, a step can be machined or cast in to the side walls. The micro-perforated panel, perforated panel, or mesh can then abut the step to form a backing space.

Further tuning trades aerodynamics of the backflow air compartment feeding the inlet-side backflow ports with the frequency attenuated. For example, the larger the backing space, the lower the frequency attenuated. But, extending the projection in to the backflow air compartment impacts aerodynamics. And, the less backing space provided, the higher the frequency attenuation.

As shown in FIG. 2, a spacer 10 can also be used with, or as an alternative to, the step 6 in the projection. The spacer 10 can be inserted to abut the edge 4, and the micro-perforated panel (first portion 8) can abut the spacer 10. Alternatively, the micro-perforated panel can abut the step 6, and the spacer 10 can be used to secure the micro-perforated panel in place.

Tradeoffs among the first portion materials include that the perforated panel or mesh panel have a greater porosity than the micro-perforated panel. Due to the greater porosity, or open space, of these alternatives, they can perform a retaining function for a porous material. Or, due to the greater porosity, these alternatives can reduce aerodynamic turbulence without reducing the recess space between the first portion and the back wall. Thus, pore sizes can range from fractions of a millimeter to several millimeters, to more than several millimeters.

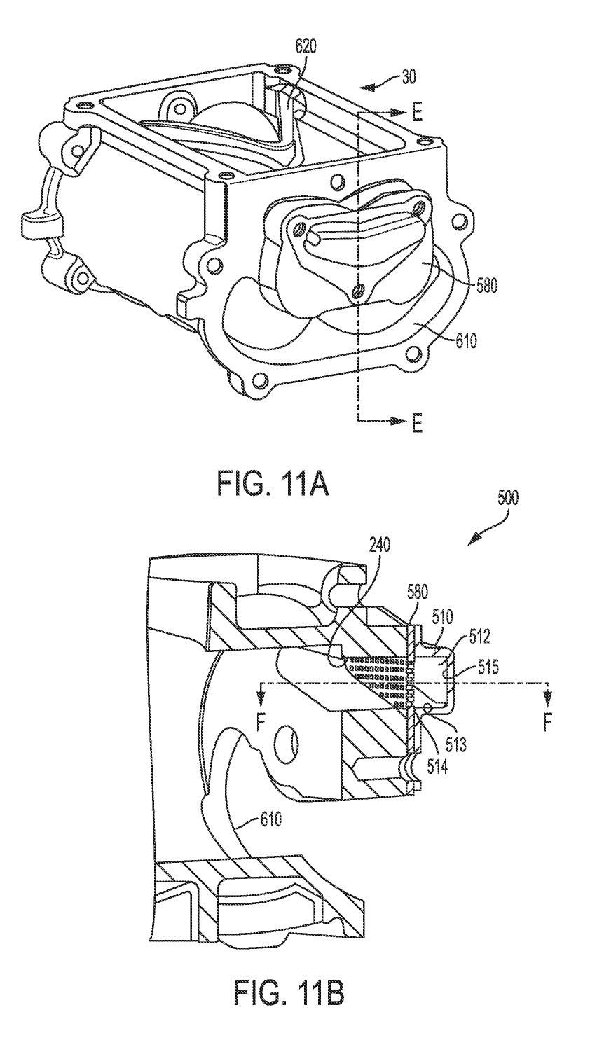

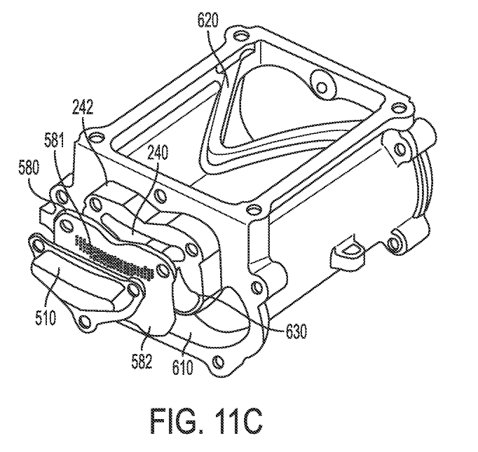

Turning to FIGS. 11A-11C, an alternative supercharger housing 30 includes an outlet 620 and inlet 610. At times, it is not possible to include radial backflow ports or axial backflow ports, as shown and discussed with respect to FIGS. 7-9. Even without these backflow ports, air can still back flow in the housing. Air can leak through the outlet 620 and leak back down the rotor towards the inlet. By providing an opening 240 above the inlet 610, it is possible to diffuse the air leaking back down the rotor towards the inlet. It is also possible to damp air being swept by the rotors from the inlet to the outlet.

An inlet panel assembly 500 is attached to the inlet plane of the housing 30. FIG. 11B is a cross section view along line E-E of FIG. 11A. A first portion can be a perforated material 580, such as a perforated or microperforated panel, that abuts the opening 240. The opening extends along an inlet panel axis F-F for a distance to damp NVH. An inlet panel 510 is bolted or otherwise secured to the housing 30 to secure the perforated material 580 to the housing 30. The inlet panel 510 comprises a backing space for further NVH damping characteristics. As above, the backing space between the back surface of the inlet panel 510 and the perforated material 580 can have a selective amount of porous material 509 to further damp NVH. The inlet panel 510 can couple to a neck 242 surrounding the opening 240. The length of the neck 242 can be adjusted to tune the damping.

While the inlet panel 510 can stack with the perforated material 580 against the housing, it is possible to use a spacer 1011, with or alternative to the neck 242, to extend a resonance space between the opening 240 and the perforations 581 of the perforated material. It is also or alternatively possible to use a spacer 1010 to extend the backing space between the inlet panel 510 and the perforated material 580. The spacers 1011 and 1010 can alternatively be a gasket or sealing material.

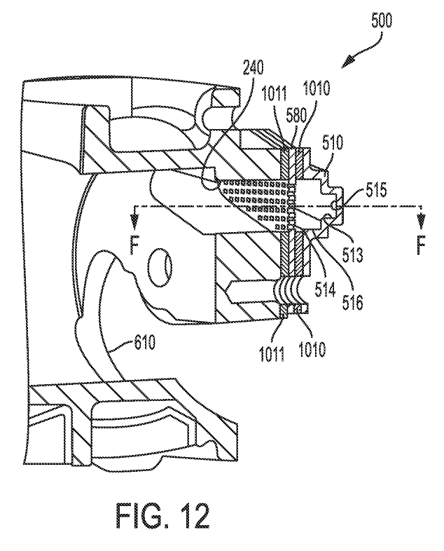

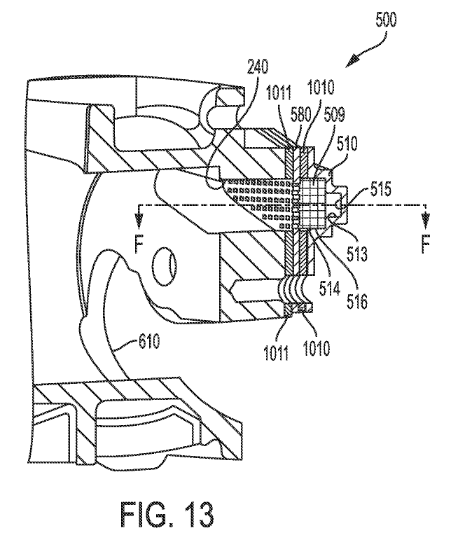

As shown in FIG. 12, it is further possible to extend the backing space by changing an inner edge of one or both of the inlet panel 510 and the spacer 1010. This can be accomplished, for example, by forming a step 516. Resonant cavities then exist within the inlet panel 510. Or, as shown in FIG. 13, the step 516 can be used to provide a restrictive surface for bracing porous material 509 at a location along the inlet panel axis F.

As shown in FIGS. 12 and 13, the inlet panel 510 comprises an edge 514 to abut the perforated material 580. The perforated material comprises perforations 581 that damp NVH in air passing from the inside of the supercharger, through the opening 240 and reflecting off the back wall 515. The recess is formed at least by the back wall 515 and the side wall 513. The step 515 can be between the side wall 513 and the edge 514. Unlike the prior examples, the perforated material is not recessed in to the inlet panel. Instead, the perforated material includes a rim 582. The rim permits holes for accepting threaded screws or other couplers for joining the inlet panel and perforated material to the housing 30, preferably by having the coupler join in the neck 242. The rim 582 also permits the provision of a sealing area to cover the rotor mounting hole 630. This permits installation and manipulation of the rotors above the inlet 610 and below the opening 240. The rotor shafts can extend into the neck 242, and the rim 582 seals the rotor mounting hole 630 against leakage of air. When a spacer 1010 or 1011 is used, the spacer can be a gasket or can comprise a sealant or coating to assist with the sealing function.

Other implementations will be apparent to those skilled in the art from consideration of the specification and practice of the examples disclosed herein. It is intended that the specification be considered as exemplary only.

1. An inlet panel for a supercharger comprising:
a first portion, the first portion comprising one of a perforated material, a micro-perforated material, and a mesh layer; and
a second portion, the second portion comprising a recess and an axis, wherein the recess is bordered in part by a side wall and a back wall,
wherein the first portion is offset from the back wall in the axial direction, and
wherein the side wall has an edge located a distance away from the back wall in the axial direction.

2. The inlet panel of claim 1, comprising a porous material between the back wall and the first portion.

3. (canceled)

4. (canceled)

5. The inlet panel of claim 1, wherein the first portion abuts the edge.

6. The inlet panel of claim 1, wherein the first portion is located between the edge and the back wall.

7. The inlet panel of claim 1, comprising a step located between the edge and the back wall, the step abutting the first portion.

8. The inlet panel of claim 7, wherein a resonant cavity adjoins a first side of the step, and wherein the first portion adjoins a second side of the step.

9. The inlet panel of claim 7, further comprising a porous material, wherein a resonant cavity adjoins the step on a first side of the step, and wherein the porous material adjoins the step on a second side of the step.

10. The inlet panel of claim 9, wherein the first portion abuts the porous material.

11. The inlet panel of claim 1, wherein the first portion is positioned in a plane parallel to the back wall.

12. The inlet panel of claim 2, wherein the porous material is positioned in a plane parallel to the back wall.

13. The inlet panel of claim 1, comprising a mounting insert, the mounting insert abutting the first portion.

14. (canceled)

15. Then inlet panel of claim 1, wherein the first portion comprises circular openings, wherein at least one opening has a diameter of less than one millimeter.

16. Then inlet panel of claim 1, wherein the first portion comprises circular openings, wherein at least one opening has a diameter within the range of one millimeter to two millimeters.

17. Then inlet panel of claim 2, wherein the porous material comprises at least one of the following materials: melamine foam, fiberglass, or mineral glue.

18. A supercharger, comprising:
a housing comprising a bore;
at least two rotors, the rotors each positioned in the bore;
a radial outlet;
an axial inlet; and
an inlet panel adjacent the inlet, the inlet panel comprising:
a first portion, the first portion comprising one of a perforated material, a micro-perforated material, and a mesh layer; and
a second portion, the second portion comprising a recess and an axis,
wherein the recess is bordered in part by a side wall and a back wall;
wherein the first portion is offset from the back wall in the axial direction, and
wherein the side wall has an edge located a distance away from the back wall in the axial direction.

19. (canceled)

20. (canceled)

21. (canceled)

22. (canceled)

23. (canceled)

24. (canceled)

25. The supercharger of claim 18, wherein the housing comprises at least one backflow port located on a plane intersecting the axial inlet, and wherein the inlet panel is connected to receive fluid from the at least one backflow port.

26. The supercharger of claim 18, wherein the housing comprises at least one backflow port located on a plane intersecting the radial outlet, and wherein the inlet panel is connected to receive fluid from the at least one backflow port.

27. The supercharger of claim 18, wherein the housing comprises at least one inlet backflow port located on a plane intersecting the axial inlet, wherein the housing comprises at least one radial backflow port located on a plane intersecting the radial outlet, and wherein the inlet panel is connected to receive fluid from the at least one inlet backflow port and from the at least one radial backflow port.

28. The supercharger of claim 18, wherein the bore comprises curvatures for the rotors, and wherein the second portion has a perimeter and at least part of the perimeter has curvatures that substantially follows the curvatures of the bores.

29. (canceled)

30. (canceled)

31. (canceled)

32. (canceled)

33. (canceled)

34. (canceled)

35. (canceled)

36. (canceled)

37. (canceled)

38. A supercharger assembly, comprising:
a housing comprising:
an inlet plane and an inlet in the inlet plane;
an outlet plane, and an outlet in the outlet plane;
at least two rotor bores connected to the inlet;
at least two rotors positioned in the at least two rotor bores; and
an opening above the inlet; and
an inlet panel assembly comprising:
a first portion comprising one of a perforated material, a micro-perforated material, and a mesh layer adjoining the opening; and
an inlet panel adjoining the perforated material to secure the perforated material against the housing.

39. The supercharger of claim 38, comprising a backing space in the inlet panel.

40. The supercharger of claim 39, comprising a porous material in the backing space in the inlet panel.

41. (canceled)

42. (canceled)

43. (canceled)

44. The supercharger of claim 38, comprising:
a step located in the inlet panel;
a second step located in the inlet panel; and
a porous material adjacent the step and a resonant cavity adjacent the second step.

45. (canceled)

46. (canceled)

47. The supercharger of claim 38, comprising a spacer between the opening and the perforated material.

48. The supercharger of claim 38, comprising a spacer between the perforated material and the inlet panel.

49. (canceled)

50. (canceled)

51. (canceled)
